(19) United States
(12) Patent Application Publication
(10) Pub. No.: US 2005/0155267 A1
(43) Pub. Date: Jul. 21, 2005

(54) Two-Sided Picture Frames

(76) Inventor: Dale Edward Hamilton, Billings, MT (US)

Correspondence Address: DALE E. HAMILTON, 2308 PINE ST., BILLINGS, MT, 59101, US

(21) Appl. No.: 10/905,739

(22) Filed: Jan. 19, 2005

Related U.S. Application Data
(60) Provisional application No. 60/481,923, filed on Jan. 20, 2004.

(51) Int. Cl. G03B 13/10; A47G 1/06

(52) U.S. Cl. 40/734

(57) ABSTRACT

Two-sided picture frames are constructed for viewing pictures, photographs, scenery, art, information, cards and the like on the front, side 1, and on the back, side 2, of each wall mounted unit. The present invention comprises framing and mounting configurations, frame embodiments and improved viewing capabilities not fully realized in the prior art. The front and back frame embodiments, finish, color, size, look, style, construction and viewable contents may be the same, different or combinations thereof. This flexibility allows quick and easy modifications at home, office and beyond to wall accents, room colors, to change a seasonal look, theme, style, and, or just to change pictures. The present invention includes embodiments to hang two-sided picture frames on walls and ways to view some embodiments on desktops and flat surfaces to view side 1 and quickly adjust an optional frame wedge to view side 2. The present invention can be made of most construction materials used in the prior art as revealed in the exemplary and preferred embodiment details of the present invention.

A primary objective of the present invention is to provide two-sided picture frames for display with one or more pictures on the front and one or more pictures on the back side of each picture frame, thus making picture changing easier, faster and more efficient.

Another objective of the present invention is to provide convenient and desirable two-sided picture frames for all ages, all categories and for all types of frame users, including residential and business users, as well as home and commercial applications. Artists and art lovers to display two paintings in one frame making it easy to change, combine and tastefully display paintings at art shows etc. using half as many frames. This embodiment has no glass in the front and back frame.

Another objective of the present invention includes not only producing embodiments that are value added and median priced, but also thin, lightweight, less expensive, fun and attractive frames having theme and object shaped embodiments made of flexible plastic, conventional, fabric and other suitable materials known to the prior art.

Another objective of the present invention is to allow quick picture changes: in the home or office; in hotels; business and commercial establishments; to give new accents to a room, to change color schemes for the current seasonal look, in art, monthly thoughts or learning materials by simply turning over a few two-sided picture frames.

Another objective of the present invention is to improve home and business efficiency by allowing more options in the same frame space with two-sided picture frames that are different on each side or not, that are unique, attractive, durable and easily packed for moving and storage.

Another objective of the present invention is to provide optional and easily detachable picture frame wedges that allow more two-sided picture frames to be displayed on: desktops, shelves, furniture and flat surfaces, as well as on walls.

Another objective of the present invention is to provide two-sided picture frames that hang on walls, windows and the like in a horizontal or vertical orientation and on either side of the frame to be able to quickly change from a horizontal to a vertical look.

In summary, the present invention provides new picture frame innovations, with increased capabilities and improved efficiencies. It is functionally needed because people and business want new ways to do more in the same space, with the same things to save time and to be more organized, to work smarter and to be unique and creative. Today, humanity is empowered more and more with new inventions, improvements and conveniences, making life better, as witnessed in laptops, computers, cell phones, palm pilots, cars, cameras, stereos, televisions, and yes in the near future these improved picture frames.

### DESCRIPTION OF THE DRAWINGS

The invention, in accordance with preferred and exemplary embodiments, together with further objects and advantages thereof, is more particularly described in the following detailed description taken in conjunction with the accompanying drawings in which:

FIG. 1 is a perspective view of the back, side 2, of a completed picture frame in accordance with exemplary and preferred embodiments of the present invention. The drawing shows left and right locking unit 18 and 20 with arrows to disclose their respective direction of movement to unlock 18 and 20 which releases locking member 5 and its locking lip 19 within the locking lip channel 14 in FIG. 2 which borders the inside of the picture frame. See FIGS. 2-7 for more embodiment details.

FIG. 2 is an exploded section taken along line 1-1 in FIG. 1 showing the frames outer shape 10 and 11, and discloses the layers and configuration that make picture viewing possible from front, side 1, and back, side 2, of the present invention. This drawing shows how front glass 4, front picture 7, backing member 6, back picture 8 and back glass 4 are positioned and secured within the frame by locking member 5 with its locking lip 19 in locking lip channel 14 and locking unit 20 in locking channel 15. In addition, the drawing shows locking unit nail or screw 17, display chamber 13 and hanging channel 12 that goes around the front and back side of the frame in accordance with this embodiment of the present invention. Also see FIGS. 1 and 7.

FIG. 3 is an exploded perspective view of locking units 18 and 20, which can be made of metal, plastic or suitable rigid materials. The locking unit lever 66, nail or screw 17, hole 21 and the directional arrows to unlock 18 and 20 mounted on member 5 is shown in FIGS. 1, 2 and 4 of the present invention.

FIG. 4 is an exploded perspective view of locking unit 20 showing locking unit lever 66 in the locked position within locking channel 15. Locking unit 20 is mounted on locking member 5 with locking unit nail or screw 17 on back frame 11 also shown in FIGS. 1-3.

FIG. 5 shows perspective views of another completed picture frame 1 in accordance with exemplary and preferred embodiments of the present invention displaying the same picture 8 in the front frame 10 and the back frame 11 with the front frame and back frame having a different finish. This is intended for use with FIGS. 1-4 and 6-7 of the present invention.

FIG. 6 shows perspective views of another completed picture frame 2 in accordance with exemplary and preferred embodiments of the present invention displaying picture 7 in front frame 10 and picture 8 in back frame 11 with the front frame and back frame having the same color and finish. This is intended for use with FIGS. 1-5 and 7 of the present invention.

FIG. 7 is an exploded perspective view showing layers of the exemplary picture frames in FIGS. 1, 2, 5 and 6 with front and back pictures 7 and 8 respectively and demonstrating different frame finishes 10 and 11, along with locking member 5. The order of the component layers, showing both the front and back layers facing front from backing member 6, is for demonstration purposes only. The completed picture frame physically and sequentially has layers 10, 4, and 7 facing the front, then backing member 6, and layers 8, 4, 11 and 5 facing the back as demonstrated in FIG. 2. Locking lip 19 on locking member 5 is shown to clarify its location in this embodiment of the present invention.

FIG. 8 is a front, side 1, perspective view of another completed picture frame in accordance with exemplary and preferred embodiments of the present invention. It shows the frame recess chamber 49 and a clear, flexible, plastic cover 41 and frame recess chamber 49 that houses the protective plastic cover 41 to hold the pictures or contents in the frame. Border 52 is printed on clear flexible plastic cover 41 as a frame mat, buffer or sub-frame in which to center the pictures or contents for viewing. A line of glue, or a suitable weld for some material combinations, is placed along bonding area 28 to permanently attach 41 and 45 to the rigid support member 43 located within the frame. Bonding area 28 is also shown in FIG. 10. Hidden from view is nail or screw 9. Additional drawing details are disclosed in FIGS. 9-13.

FIG. 9 is a compressed section taken along centerline 4-4 in FIG. 8 disclosing how the frame hangs on wall 16 in using nail or screw 9. It also shows the frame recess chamber 49 that houses the protective plastic cover 41 in FIGS. 8-10 and 13 of this exemplary and preferred embodiment.

FIG. 10 is an exploded section of FIG. 9 taken along centerline 4-4 in FIG. 8 and discloses how the embodiment hangs on wall 16 using nail or screw 9 in hanging channel 12 that goes around the perimeter of each frame 40 and 46, also shown in FIG. 13. Glue or a compact weld for some materials is placed along bonding area 28 to attach the clear flexible plastic cover 41 and 45 to the rigid support member 43 creating a protective pocket to hold pictures 42 and 44 within frame recess chamber 49. Pull tabs 47 and 48 can be pulled outward, thus folding the clear flexible plastic covers 41 or 45 inward and exposing the elongated edges of 41 or 45 from within the left, right and bottom edges of the frame recess chamber 49, allowing access to change pictures. After the picture is installed, fold a right or left corner of the clear flexible plastic cover 41 or 45 inward and slide it into the lower bottom right or left corner of the frame recess chamber 49, 1 side at a time, and push inward toward picture 42 or 44 using the plastic cover surface 41 or 45 and pull tab 47 or 48 respectively. This installs the clear flexible plastic cover 41 or 45 back into place. See FIG. 13 for a further perspective view of items 40-49 in this embodiment of the present invention.

FIG. 11 is an exploded, flat, front view of clear plastic pull tab 47, which is part of the clear flexible plastic cover 41 in FIG. 8. Related details are disclosed in FIGS. 8-10, 12-13, and in the detailed description of the present invention.

FIG. 12 is another exploded view of the clear plastic pull tab 47 taken along line 4-4 in FIG. 8 and shows another view of how the folded pull tabs 47 and 48 are part of the front and back clear plastic cover layers 41 and 45 respectively. Related details are disclosed in FIGS. 8-11, 13, and in the detailed description of the present invention.

FIG. 13 is a modified perspective view showing frame layers and sample pictures 42 and 44 with the same front and back frame finish 40 and 46 respectively. The components are shown with front and back layers facing front from a rigid support member 43 for demonstration purposes only. The actual order of the layers is disclosed in FIG. 10 and in written comments on this drawing.

FIG. 14 is a baseball shaped, back or side 2, perspective view of another completed picture frame in accordance with exemplary and preferred embodiments of the present invention. It shows a clear, flexible, plastic cover layer functioning as a locking and protective surface 32 for pictures behind picture area 22 also shown in FIGS. 15-21. In addition, FIG. 14 is intended to have the same look, functionality, construction and materials as the exemplary and preferred embodiments of the present invention disclosed in FIGS. 28-48. The frame is to be tastefully adorned.

FIG. 15 is an exploded section taken along centerline 5-5 in FIG. 14 that shows layers of the completed picture frame in accordance with this exemplary and preferred embodiment of the present invention hanging on wall 16 with nail or screw 9 and demonstrates the outer edge, cross sectional shape to be used for this embodiment of the present invention, as well as for FIGS. 28-48 embodiment shapes.

FIG. 16 is an exploded section taken along centerline 5-5 in FIG. 14 that shows the layers of the completed picture frame in accordance with this exemplary and preferred embodiment of the present invention hanging on a wall. FIG. 16 also shows a flat frame surface and corners with a 90 degree cross sectional shape, along the outer edge that can also be used for this preferred embodiment of the present invention, as well as in FIGS. 28-48 embodiment shapes.

FIG. 17 is a compressed section taken along centerline 5-5 in FIG. 14 and gives a layer touching layer perspective view of the completed picture frame in accordance with another exemplary and preferred embodiment of the present invention. More details are provided in FIG. 15.

FIG. 18 is a compressed section taken along centerline 5-5 in FIG. 14 and gives another layer touching layer perspective view of the completed picture frame in accordance with another exemplary and preferred embodiment of the present invention. More details are provided in FIG. 16.

FIG. 19 is a compressed section taken along centerline 5-5 in FIG. 14 similar to that in FIGS. 17 and 18 showing frame shape variation with layer touching layer of the completed picture frame in accordance with another exemplary and preferred embodiment of the present invention.

FIG. 20 is an exploded section taken along horizontal line 6-6 in FIG. 14 of the completed picture frame in accordance with exemplary and preferred embodiments of the present invention, and further showing the flat frame surface and corners with a 90 degree cross sectional frame shape in FIGS. 16, 18 and 21.

FIG. 21 is a compressed section taken along horizontal line 6-6 in FIG. 14 that gives another layer touching layer perspective of the completed picture frame in accordance with exemplary and preferred embodiments of the present invention, and further showing the flat surface and corners with a 90 degree shape in FIGS. 16, 18 and 20.

FIG. 22 is the same as FIG. 14 but with a different hanging embodiment that can be hung on a wall so the hole is visible or hidden behind the frame when hanging on a wall as shown in FIGS. 23 and 27. The frame is to be tastefully adorned.

FIG. 23 is an exploded section taken along centerline 7-7 in FIG. 22 that shows layers of the completed picture frame in accordance with exemplary and preferred embodiments of the present invention where the frame is hanging on a wall 16 with nail 9, which is hidden from the viewer as shown in FIG. 27.

FIG. 24 is an exploded section taken along centerline 7-7 in FIG. 22 that shows layers of the completed picture frame in accordance with exemplary and preferred embodiments of the present invention. It shows where the frame can hang on a wall via hole 37 with nail 9 in FIG. 23, in which case hole 37 and nail 9 would be visible to the viewer as shown in FIG. 26.

FIG. 25 is a perspective view of a completed picture frame in FIG. 14 with a visible hole for hanging on a wall or the like, as compared to FIG. 26 with a variation of a visible hanging hole and FIG. 27 with a hidden hole for the wall mounted embodiment of the present invention.

FIG. 26 is a perspective view of a completed picture frame in FIGS. 22 and 24 with visible hole 37 configuration for hanging on a wall or the like and also relates to FIGS. 14-19.

FIG. 27 is a perspective view of a completed picture frame in FIG. 23 with the hole 37 hidden (not shown) when hanging on a wall or the like, and also relates to FIGS. 14-19 and 25-26 in accordance with exemplary and preferred embodiments of the present invention.

FIG. 28 is a heart shaped perspective view of another completed picture frame in accordance with exemplary and preferred embodiments of the present invention. It is constructed using ideas and methods in FIGS. 14-27, but may have more quintessence with embodiments in FIGS. 1-13 or 67-70. The frame is to be tastefully adorned.

FIG. 29 is a birthday cake shaped perspective view of another completed picture frame in accordance with exemplary and preferred embodiments of the present invention. It is constructed using ideas and methods in FIGS. 14-27, but may have more quintessence with embodiments in FIGS. 1-13 or 67-70. The frame is to be tastefully adorned.

FIG. 30 is a baseball shaped perspective view of another completed picture frame in accordance with exemplary and preferred embodiments of the present invention. Since this shape is round the adornments can change to depict many things on the front, back or both, such as: a bowling ball, basketball, tennis ball, golf ball, soccer ball, hockey puck, racket ball and the like. These are constructed using ideas and methods in FIGS. 14-27, but may have more quintessence with embodiments in FIGS. 1-13 or 67-70. The frame is to be tastefully adorned.

FIG. 31 is a football shaped perspective view of another completed picture frame in accordance with exemplary and preferred embodiments of the present invention. It is constructed using ideas and methods in FIGS. 14-27, but may have more quintessence with embodiments in FIGS. 1-13 or 67-70. The frame is to be tastefully adorned.

FIG. 32 is a Halloween pumpkin shaped perspective view of another completed picture frame in accordance with exemplary and preferred embodiments of the present invention. It is constructed using ideas and methods in FIGS. 14-27, but may have more quintessence with embodiments in FIGS. 1-13 or 67-70. The frame is to be tastefully adorned.

FIG. 33 is a Christmas tree shaped perspective view of another completed picture frame in accordance with exemplary and preferred embodiments of the present invention. It is constructed using ideas and methods in FIGS. 14-27, but may have more quintessence with embodiments in FIGS. 1-13 or 67-70. The frame is to be tastefully adorned.

FIG. 34 is a pyramid shaped perspective view of another completed picture frame in accordance with exemplary and preferred embodiments of the present invention. It is constructed using ideas and methods in FIGS. 14-27, but may have more quintessence with embodiments in FIGS. 1-13 or 67-70. The frame is to be tastefully adorned.

FIG. 35 is a basket shaped perspective view of another completed picture frame in accordance with exemplary and preferred embodiments of the present invention. It is constructed using ideas and methods in FIGS. 14-27, but may have more quintessence with embodiments in FIGS. 1-13 or 67-70. The frame is to be tastefully adorned.

FIG. 36 is a fish shaped perspective view of another completed picture frame in accordance with exemplary and preferred embodiments of the present invention. It is constructed using ideas and methods in FIGS. 14-27, but may have more quintessence with embodiments in FIGS. 1-13 or 67-70. The frame is to be tastefully adorned.

FIG. 37 is an abstract rectangular or perhaps a Chess Board shaped perspective view of another completed picture frame in accordance with exemplary and preferred embodiments of the present invention. It is constructed using ideas and methods in FIGS. 14-27, but may have more quintessence with embodiments in FIGS. 1-13 or 67-70. The frame is to be tastefully adorned.

FIG. 38 is a solid color rectangular shaped perspective view of another completed picture frame, having a star shaped hole through the frame for hanging on a wall on side 1 or side 2, in accordance with exemplary and preferred embodiments of the present invention. It is constructed using ideas and methods in FIGS. 14-27, but may have more quintessence with embodiments in FIGS. 1-13 or 67-70. The frame is to be tastefully adorned.

FIG. 39 is a maple leaf shaped perspective view of another completed picture frame in accordance with exemplary and preferred embodiments of the present invention. It is constructed using ideas and methods in FIGS. 14-27, but may have more quintessence with embodiments in FIGS. 1-13 or 67-70. The frame is to be tastefully adorned.

FIG. 40 is a rectangular shaped perspective view of a completed picture frame collage with rounded corners in accordance with exemplary and preferred embodiments of the present invention. It is constructed using ideas and methods in FIGS. 14-27, but may have more quintessence with embodiments in FIGS. 1-13 or 67-70. This embodiment shows 10 pictures, has a chain for hanging, and the frame is to be tastefully adorned.

FIG. 41 is a hot air balloon shaped perspective view of a picture frame collage in accordance with exemplary and preferred embodiments of the present invention. It is constructed using ideas and methods in FIGS. 14-27, but may have more quintessence with embodiments in FIGS. 1-13 or 67-70. This embodiment shows 12 equal sized pictures, and the frame is to be tastefully adorned.

FIG. 42 is a hot air balloon shaped perspective view of a picture frame collage in accordance with exemplary and preferred embodiments of the present invention. It is constructed using ideas and methods in FIGS. 14-27, but may have more quintessence with embodiments in FIGS. 1-13 or 67-70. This embodiment shows 4 equal sized pictures, and the frame is to be tastefully adorned.

FIG. 43 is a rectangular shaped perspective view of a completed picture frame with rounded corners in accordance with exemplary and preferred embodiments of the present invention. It is constructed using ideas and methods in FIGS. 14-27, but may have more quintessence with embodiments in FIGS. 1-13 or 67-70. It has a rope around the entire frame for hanging and the frame is to be tastefully adorned.

FIG. 44 is a rectangular shaped perspective view of a picture frame collage with a wider frame for theme scenes and the like, such as an underwater tropical reef with sea life and fish to compliment scuba diving pictures in accordance with exemplary and preferred embodiments of the present invention. It is constructed using ideas and methods in FIGS. 14-27, but may have more quintessence with embodiments in FIGS. 1-13 or 67-70. This embodiment shows 12 pictures, and the frame is to be tastefully adorned in addition to the heart in the upper right corner.

FIG. 45 is a rose shaped perspective view of another completed picture frame in accordance with exemplary and preferred embodiments of the present invention. It is constructed using ideas and methods in FIGS. 14-27, but may have more quintessence with embodiments in FIGS. 1-13 or 67-70. This embodiment has a smaller heart shaped viewing area with a similar clear plastic covered pocket that holds smaller pictures in the front and the back, and the frame is to be tastefully adorned.

FIG. 46 is a cruise ship shaped perspective view of another completed picture frame in accordance with exemplary and preferred embodiments of the present invention. It is constructed using ideas and methods in FIGS. 14-27, but may have more quintessence with embodiments in FIGS. 1-13 or 67-70. This embodiment shows 2 picture areas, and the frame is to be tastefully adorned.

FIG. 47 is another rectangular shaped perspective view of a completed picture frame with rounded corners in accordance with exemplary and preferred embodiments of the present invention. It is constructed using ideas and methods in FIGS. 14-27, but may have more quintessence with embodiments in FIGS. 1-13 or 67-70. It has a chain for hanging and the frame is to be tastefully adorned.

FIG. 48 is another rectangular shaped perspective view of a completed picture frame with rounded corners in accordance with exemplary and preferred embodiments of the present invention. It is constructed using ideas and methods in FIGS. 14-27, but may have more quintessence with embodiments in FIGS. 1-13 or 67-70. It has a small rope, string, wire or the like for hanging, and the frame is to be tastefully adorned.

FIG. 49 is a section taken along line 2-2 in FIG. 1 showing optional small frame wedge 33 mounted on the back, side 2, of FIG. 1 to allow desktop or horizontal surface viewing of the front, side 1 of embodiments in FIGS. 1 and 8 of the present invention. See FIGS. 50-54 for additional drawings.

FIG. 50 is a section taken along line 2-2 in FIG. 1, and shows optional small frame wedge 33 mounted on the front, side 1, of FIG. 1 to allow desktop or horizontal surface viewing of the back, side 2, of embodiments in FIGS. 1 and 8 of the present invention. See FIGS. 51-54 for additional drawings.

FIG. 51 is a perspective view of optional small frame wedge 33 with its frame wedge foot 35 and two frame wedge boots 36 used for supporting the front or back side in desktop or horizontal surface viewing of embodiments like those in FIGS. 1 and 8 of the present invention. See FIGS. 49-50 and 52-54 for additional drawings.

FIG. 52 is a section taken along line 9-9 in FIG. 51, and shows another perspective view of optional small frame wedge 33, frame wedge foot 35 and two frame wedge boots 36 used for supporting the front and back sides for desktop or horizontal surface viewing of embodiments like those in FIGS. 1 and 8 of the present invention. See FIGS. 49-51 and FIGS. 53-54 for additional drawings.

FIG. 53 is a perspective view of the frame wedge foot 35, which is part of optional small frame wedge 33 in FIG. 51 used for supporting the front and back sides for desktop or horizontal surface viewing of embodiments like those in FIGS. 1 and 8 of the present invention. See FIGS. 49-52 and FIG. 54 for additional drawings.

FIG. 54 is an exploded perspective view of the frame wedge foot 35, which is part of optional small frame wedge 33 in FIG. 51 used for supporting the front and back sides for desktop or horizontal surface viewing of embodiments like those in FIGS. 1 and 8 of the present invention. See FIGS. 49-53 for additional drawings.

FIG. 55 is a section taken along line 2-2 in FIG. 1, and shows optional nautilus frame wedge 51 mounted on the front, side 1, of FIG. 1 to allow desktop or horizontal surface viewing of the back, side 2, of embodiments in FIGS. 1 and 8 of the present invention. See FIGS. 56-60 for additional drawings.

FIG. 56 is a section taken along line 2-2 in FIG. 1, and shows optional nautilus frame wedge 51 mounted on the back, side 2, of FIG. 1 to allow desktop or horizontal surface viewing of the front, side 1 of embodiments in FIGS. 1 and 8 of the present invention. See FIGS. 55 and 57-60 for additional drawings.

FIG. 57 is a perspective view of optional nautilus frame wedge 51 and frame wedge foot 50 used for supporting the front or back side for desktop or horizontal surface viewing of embodiments like those in FIGS. 1 and 8 of the present invention. See FIGS. 55-56 and 58-60 for additional drawings.

FIG. 58 is a section taken along line 10-10 in FIG. 57, and shows another perspective view of optional nautilus frame wedge 51 and frame wedge foot 50 used for supporting the front and back sides for desktop or horizontal surface viewing of embodiments like those in FIGS. 1 and 8 of the present invention. See FIGS. 55-57 and 59-60 for additional drawings.

FIG. 59 is a perspective view of the frame wedge foot 50, which is part of optional nautilus frame wedge 51 in FIG. 57 used for supporting the front and back sides for desktop or horizontal surface viewing of embodiments like those in FIGS. 1 and 8 of the present invention. See FIGS. 55-58 and 60 for additional drawings.

FIG. 60 is an exploded perspective view of the frame wedge foot 50, which is part of the optional nautilus frame wedge 51 in FIG. 57 used for supporting the front and back sides for desktop or horizontal surface viewing of embodiments like those in FIGS. 1 and 8 of the present invention. See FIG. 55-59 for additional drawings.

FIG. 61 is a section taken along line 2-2 in FIG. 1, and shows optional large frame wedge 34 mounted on the back, side 2, for desktop or horizontal surface viewing of the front, side 1, for large embodiments like those in FIGS. 1 and 8 of the present invention. It is worth noting that distance 59 in FIG. 2 must be the same as the inside picture viewing distance 68 within locking member 5 in FIG. 1 for the optional large frame wedge 34 to fit the front and back frame sides properly. See FIGS. 62-66 for additional drawings and information.

FIG. 62 is a section taken along line 2-2 in FIG. 1, and shows optional large frame wedge 34 mounted on the front, side 1, for desktop or horizontal surface viewing of the back, side 2, for large embodiments like those in FIGS. 1 and 8 of the present invention. It is worth noting that distance 59 in FIG. 2 and related drawings must be the same as the inside picture viewing distance of locking member 5 for optional large frame wedge 34 for side 1 and side 2 of the frame to fit properly. See FIGS. 61 and 63-66 for additional drawings.

FIG. 63 is a perspective view of optional large frame wedge 34 with its two frame wedge feet 57 and frame wedge boot 36 used for supporting large frame front or back sides for desktop or horizontal surface viewing of large embodiments like those in FIGS. 1, 2, 8 and 9 of the present invention. Read the details explaining FIG. 64 carefully to calculate optional large frame wedge 34 dimensions. It is worth noting that distance 59 in FIG. 2 must be the same as the inside picture viewing distance 68 within locking member 5 in FIG. 1 for the optional large frame wedge 34 to fit the front and back frame sides properly. Similarly, distances 58 and 59 in FIG. 2 must be equal on the front and back sides of FIGS. 8-10 for wedge 34 to fit properly. See FIGS. 61-62 and 64-66 for additional drawings and information.

FIG. 64 is a section taken along line 1-1 in FIG. 63, and shows another perspective view of optional large frame wedge 34 with its two frame wedge feet 57, edge 56, and frame wedge boot 36 used to support large frame embodiments for desktop or horizontal surface viewing like those in FIGS. 1-2 and 8-10 of the present invention. Important: The length for large frame wedge 34 when supporting FIG. 1 embodiments is the distance 58 in FIG. 2 measured as a straight line between points 64 and 65 in FIG. 64. A second key length for large frame wedge 34 when supporting FIG. 1 embodiments is the distance 59 in FIG. 2 measured as a straight line between points 62 and 63 in FIG. 64. Similarly, the length for large frame wedge 34 when supporting FIG. 8 embodiments is the distance 55 in FIG. 9 measured as a straight line between points 64 and 65 in FIG. 64. A second key length for large frame wedge 34 when supporting FIG. 8 embodiments is the distance 54 in FIG. 9 measured as a straight line between points 62 and 63 in FIG. 64. Circle diameters 60 and 61 disclose the proper lengths for large frame wedge 34 to slide and rotate into the frame support position shown in FIGS. 61-62 of the present invention. In addition, an alternative arc shaped outer edge for the two optional frame wedge feet 57 is revealed between points 64 and 56 in FIG. 64. This creates the best fit for large frame wedge 34, using what can be called arc frame wedge feet 57, within the frames of the present invention. See FIGS. 61-63 and 65-66 for additional drawings.

FIG. 65 is a perspective view of a frame wedge foot 57, which is part of the optional large frame wedge 34 in FIG. 63 used for supporting the frames front or back side for desktop or horizontal surface viewing of large embodiments like those in FIGS. 1 and 8 of the present invention. See FIGS. 61-64 and 66 for additional drawings.

FIG. 66 is an exploded perspective view of a frame wedge foot 57 including edge 56, which is part of the optional large frame wedge 34 in FIGS. 63-64 used for supporting the frames front or back side for desktop or horizontal surface viewing of large embodiments like those in FIGS. 1 and 8 of the present invention. See FIGS. 61-65 for additional drawings.

FIG. 67 is a section taken along the centerline 2-2 in FIG. 1 showing the frame and layers in accordance with this embodiment of the present invention and how hanging channel 12, built into the frame, accommodates hanging the present invention on wall 16, either on the front or back of any of the 4 sides using nail or screw 9 and the like. It also shows how locking member 5 functions with locking lip 19 in locking channel 14 along the top frame of the present invention.

FIG. 68 is a section taken along horizontal line 3-3 in FIG. 1 showing the frame and layers along the sides of the present invention and how hanging channel 12, built into the frame, accommodates hanging the present invention on wall 16, either on the front or back of any of the 4 sides therein using nail or screw 9 and the like. It also shows locking member 5 and how it is positioned along the sides of the present invention. Notice in this view that locking member 5 has no locking lip 19 along the sides of the frame embodiment as compared to FIG. 67.

FIG. 69 is a section taken along line 1-1 in FIG. 1 showing another exemplary shape of this frame embodiment wherein locking member 5 and locking unit 20 is present on both front and back sides and how hanging channel 12, built into the frame, accommodates hanging the present invention on walls, either on the front or back of any of the 4 sides therein using nails, screws and the like. It also shows how the locking member 5 functions along the top and bottom of the front, side 1, and the back, side 2, in accordance with the present invention.

FIG. 70 is a further compressed section taken along line 1-1 in FIG. 1 showing still another exemplary frame shape of this embodiment with its layers, locking member 5 and locking unit 20 on the back, side 2, in accordance with the present invention.

### DESCRIPTION OF THE PREFERRED EMBODIMENTS

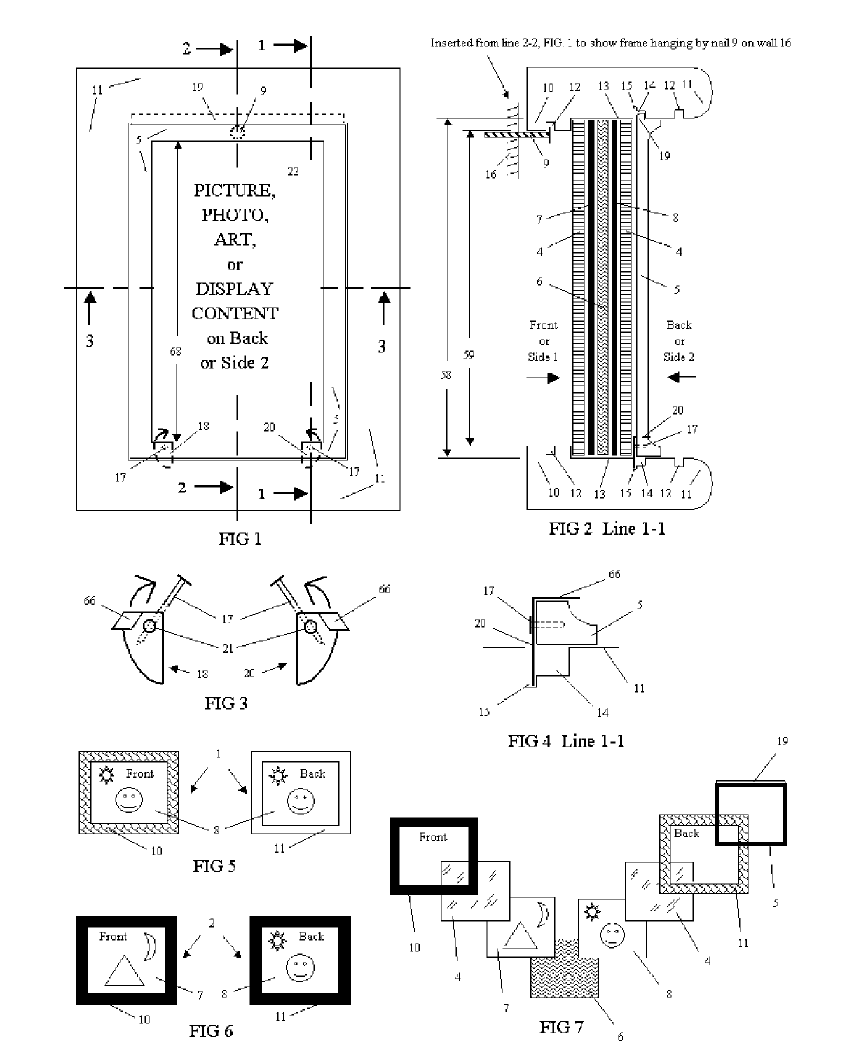

Turning now with reference to the drawings in FIGS. 1 thru 7, please find an embodiment and features of the present invention, which comprises a frame structure, made of prior art materials, and contains the following: front side glass 4, front side picture 7, center member 6, back side picture 8, back side glass 4, locking member 5 and attached locking units 18 and 20 shown in FIGS. 1 and 2. The function and alignment of locking units 18 and 20 is revealed in FIGS. 1-4. In addition, FIGS. 5-7 illustrate the flexibilities of frames 1 and 2 with front frame 10 and back frame 11 having pictures 7 and 8 displayed with the same or different pictures, frame finish, color, look or combinations thereof. Locking lip 19 on locking member 5, shown in FIGS. 1, 2 and 7, locks into lip locking channel 14, while locking units 18 and 20 are positioned into locking channel 15 in this embodiment of the present invention. An alternative for hanging channel 12 in FIGS. 1, 2, 5, 6 and 7, which spans the inside perimeter along the front and back sides of the frame, is to form, cast, cut or otherwise create hanging channel 12 only in the frame area where nail or screw 9 in FIGS. 1 and 2 would be located on 1 or more sides of the front and back frame to minimize its visibility. This can be called a mini-hanging channel 12. It is important to manufacture and assemble all items, especially items 10 to 15 in FIGS. 1-7, with due diligence to insure proper fit and alignment of items 4 to 9 and 17 to 21 and to produce a quality product.

To install or replace pictures in this embodiment, gently pull upward on the locking unit lever 66 of locking units 18 and 20, rotating locking unit lever 66 approximately 90 degrees, to release locking units 18 and 20 and locking member 5 from the frame. Gently remove locking member 5 to access frame layers as illustrated in FIGS. 1 and 2. When finished gently place locking member 5 into the frame with locking lip 19 placed in locking lip channel 14 and gently push downward on locking unit levers 66 until flush with the surface of locking member 5, thus securing locking units 18 and 20 and completing the installation.

One of the objectives of this embodiment is to provide some elegant looking frames suitable for artists and art lovers to display two paintings in one frame making it easy to change, combine and tastefully display paintings using half as many frames. Art lovers can easily make changes in seasonal looks, art themes and room accents by simply turning over a few two-sided picture frames. This application has no glass in the front or the back frame, and it is not necessary in order to lock the paintings into this embodiment of the present invention.

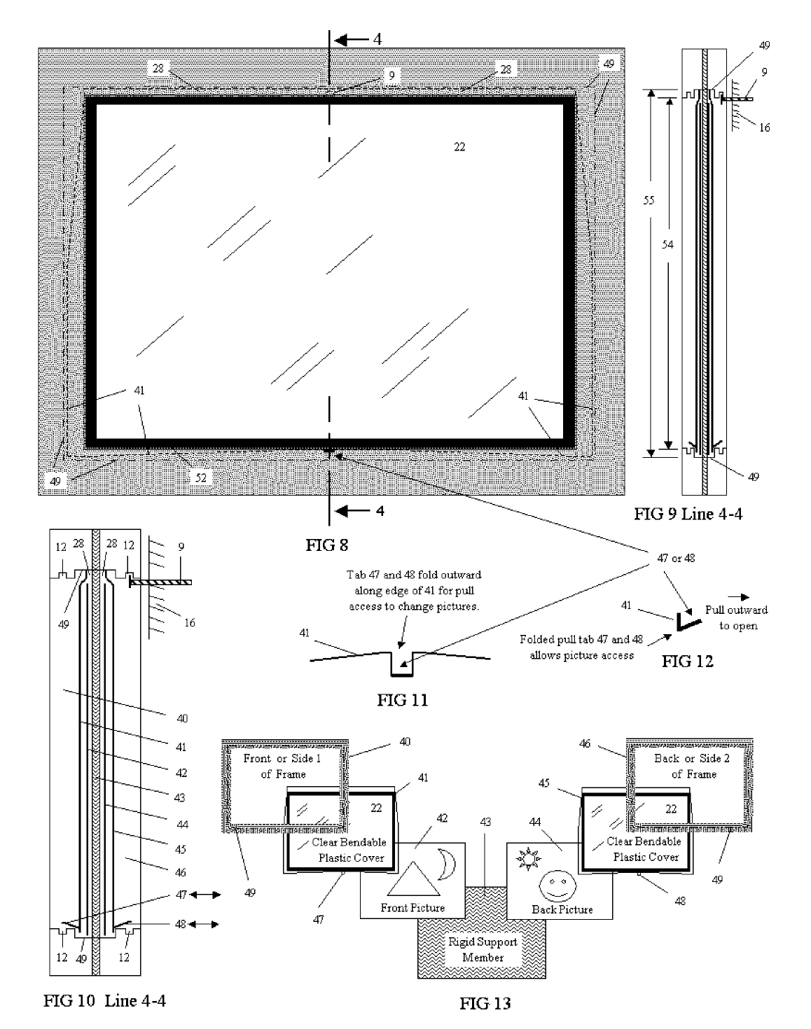

Drawings in FIGS. 8 thru 13 reveal another embodiment and features of the present invention, which comprises a frame structure, made of prior art materials, and contains the following: flexible front side clear plastic cover 41, front side picture 42, rigid support member 43, back side picture 44 and flexible back side clear plastic cover 45 shown in FIGS. 8-10.

To install or replace pictures in this embodiment gently pull outward on pull tab 47 or 48, which is part of flexible clear plastic cover 41 or 45 to gain access to picture 42 or 44 respectively, shown in FIGS. 8-13. When finished center the picture in the viewing area 22 in FIG. 8, raise pull tab 47 or 48 a few inches above the frame surface while gently press the corner edges of flexible clear plastic cover 41 or 45 inward to align the corners and edges of 41 or 45 for re-entry into recess chamber 49. Notice that aligning and inserting the corners and edges is easier if done one corner at a time. Gently press the corner edges of flexible clear plastic cover 41 or 45 into recess chamber 49 until said clear plastic covers 41 and 45 are flat and touching the picture, thus completing the installation.

Border 52 is printed on the flexible clear flexible plastic covers 41 and 45 as a frame mat, buffer area or sub-frame in which to center the picture or contents for viewing. In area 28 and above viewing area 22, a line of glue or a suitable weld for some material combinations is placed to permanently attach 41and 45 to the rigid support member 43 located in the frame.

The embodiment in FIGS. 8-13 of the present invention can have the same or different: pictures, frame finish, color, look or combinations thereof and it also has a wall hanging channel 12 built into the front and back frame. An alternative for hanging channel 12 in FIGS. 8-10, which spans the inside perimeter along the front and back sides of the frame, is to form, cast, cut or otherwise create hanging channel 12 only in the frame area where nail or screw 9 in FIGS. 8-10 would be located on 1 or more sides of the front and back frame to minimize its visibility. It is important to manufacture and assemble all frame items, especially items 12, 40, 41, 43, 45, 46, 49 and 52 in FIGS. 8-13, with due diligence to insure their proper fit and alignment and to produce a quality product.

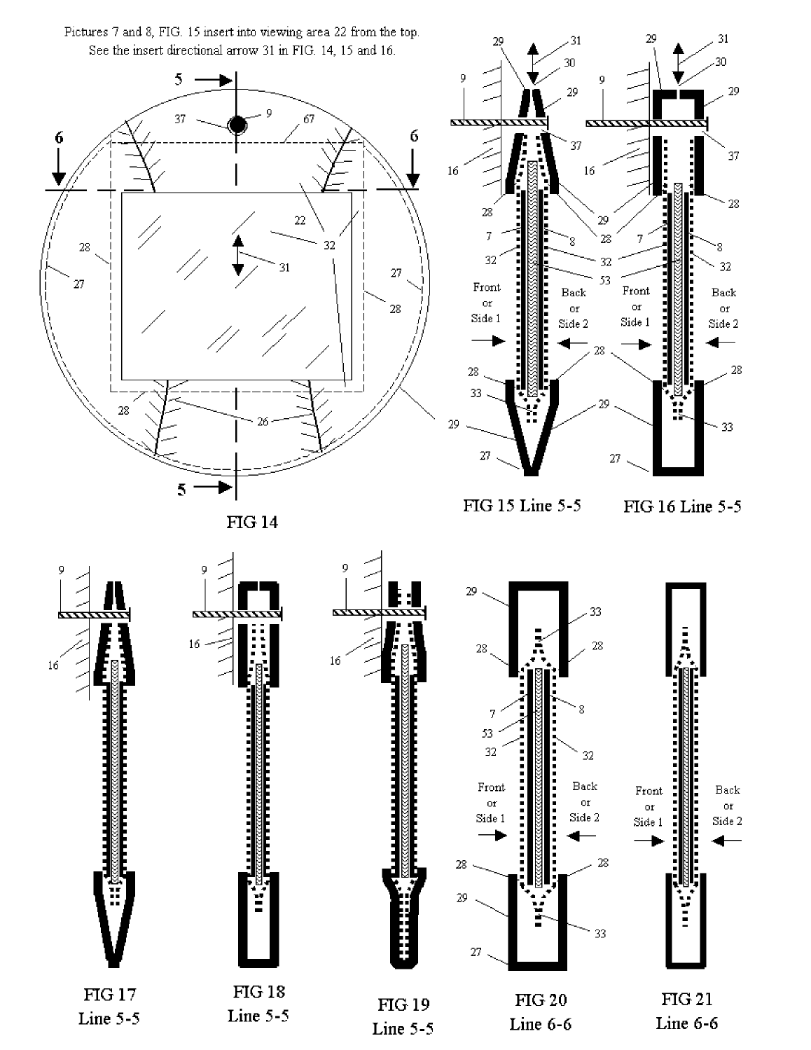

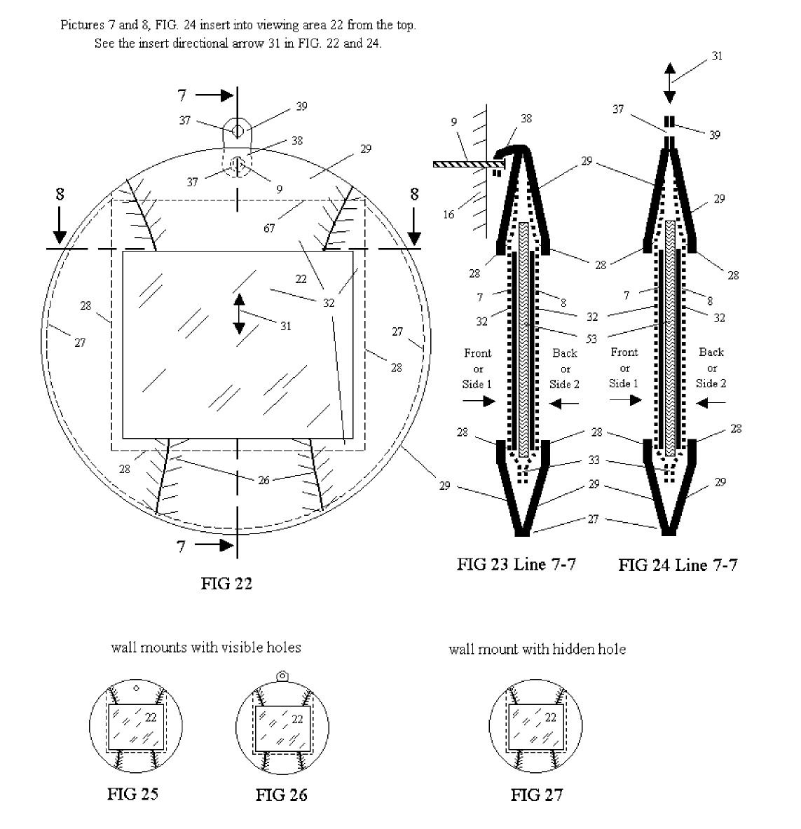

The drawings in FIGS. 14 thru 48 reveal more embodiments and features of the present invention, which comprises a front and back frame cover 29 in FIGS. 14-16 and 22-24, made of flexible plastic, fabric, or materials known to the art that is thin, lightweight, less expensive but attractive, and contains the following: front and back flexible clear plastic cover pocket 32 that borders along line 28 between front and back picture area 22 and is glued, welded or affixed to the front and back frame cover 29 at line 28. Next, front and back pictures 7 and 8 with center member 53 located between pictures 7 and 8. This embodiment creates a pocket bread like frame in which the front and back frame cover 29 and flexible clear plastic cover pocket 32 are glued, welded or otherwise permanently attached to each other and to themselves at lines and areas 27, 28 and 33. The front and back sides of flexible clear plastic cover pocket 32 is also glued, welded or otherwise permanently attached along top line 67 in FIGS. 14 and 22 to the front and back insides of frame cover 29 respectively.

To install or replace pictures in this embodiment, remove frame cover 29 from wall 16 and nail or screw 9 in FIG. 14-15 or 22-23. Open the frame opening 30 at the top of frame 29 to access the inside of the flexible clear plastic cover pocket 32. Access is now achieved to pictures 7 and 8 and center member 53. When finished squeeze the top of frame cover 29 together until front and back sides touch and place nail or screw 9 through hole 37 in FIGS. 14-16 or 22-24 on wall 16 to complete the installation.

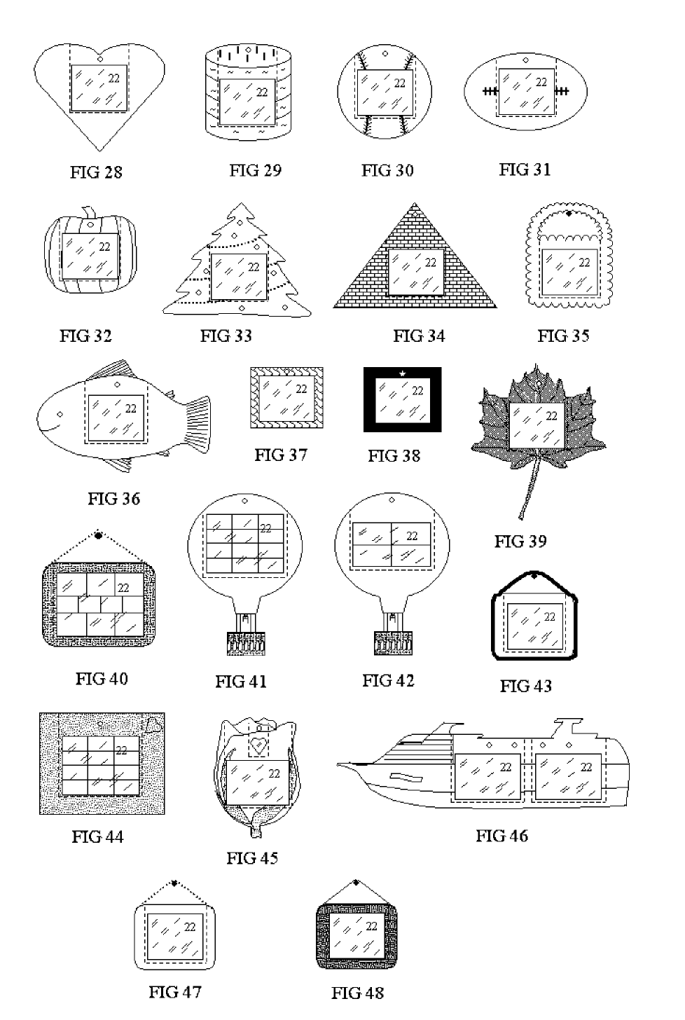

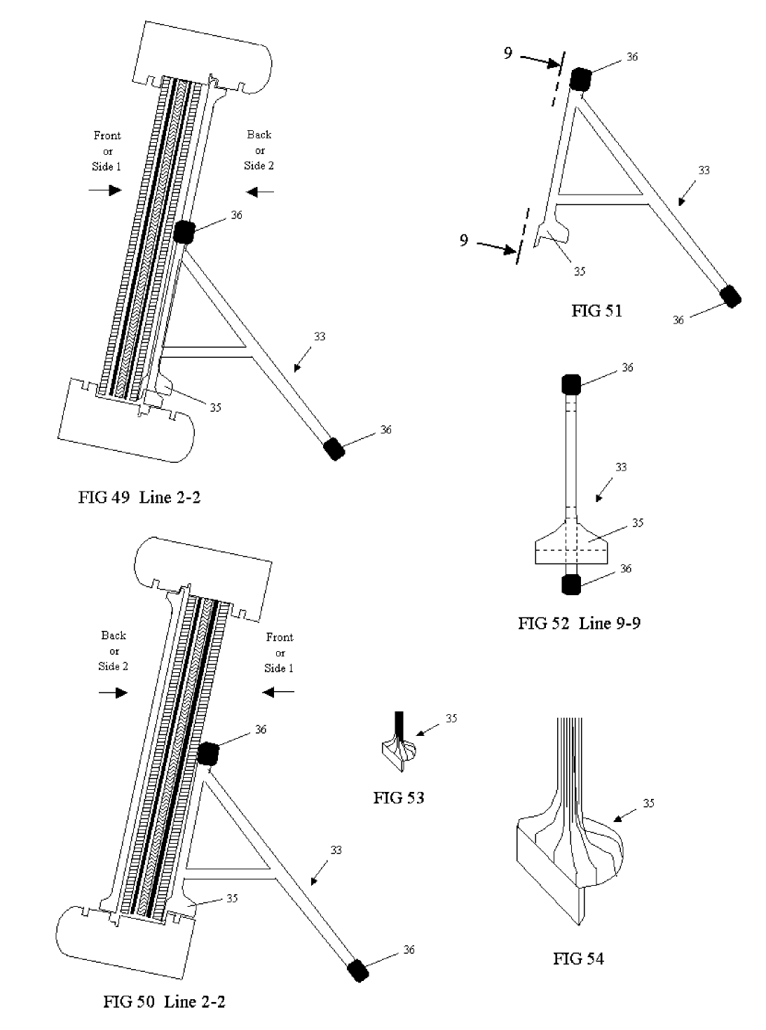

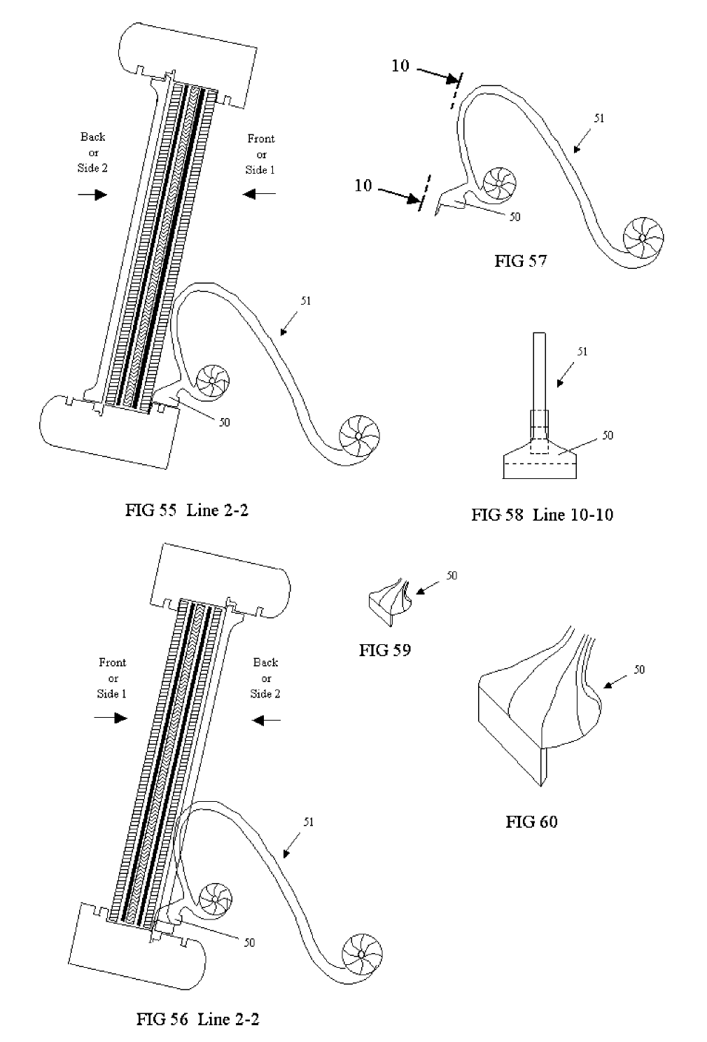

The look, features, embodiment details, materials, construction, and configurations given in and for FIGS. 14-27 apply to embodiment variations. The additional features in FIGS. 28-48 may need to adjust somewhat to accommodate the varying shapes of the objects they are depicting and hanging exceptions. Adornments and finishes should be tastefully provided to match the themes, subjects and respective shapes of the embodiments. However, some of the embodiments in FIGS. 28-48 may have more quintessence, or be more aesthetically pleasing given embodiments in FIGS. 1-7 or FIGS. 8-13 in accordance with exemplary and preferred embodiments of the present invention.

Drawings in FIGS. 49 thru 54 reveal an optional desktop frame support for wall mounted frames in FIGS. 1 and 8 of the present invention and comprises a small frame wedge 33 with its built-in frame wedge foot 35 and two slip resistant frame wedge boots 36. Small frame wedge 33 shown in FIG. 51 is made of metal, wood, plastic, cast or materials known to the art and can be cast, cut, formed, poured, fabricated and the like with techniques used in the art. This support should usually have a black, brass, chrome or white looking finish to add a fashionable touch and compliment any frame finish.

To install small frame wedge 33, which fits snugly at the centerline between the frame and glass shown in FIGS. 2 and 50 or between the frame and plastic cover in FIGS. 10 and 13, hold small frame wedge 33 vertically near the lower frame centerline. Gently press the lower edge of wedge foot 35 seen in FIG. 54 in between the frame and front or back glass 4 in FIG. 2 or plastic cover 41 or 45 in FIG. 10. Continue sliding wedge foot 35 into display chamber 13 in FIG. 2 or frame recess chamber 49 in FIG. 10 until a snug fit is achieved, as illustrated in FIGS. 49 and 50. This completes the installation.

Optional small frame wedge 33 provides a desktop or flat surface viewing capability for small and medium wall mounted embodiments in accordance with the versatility intended for the present invention.

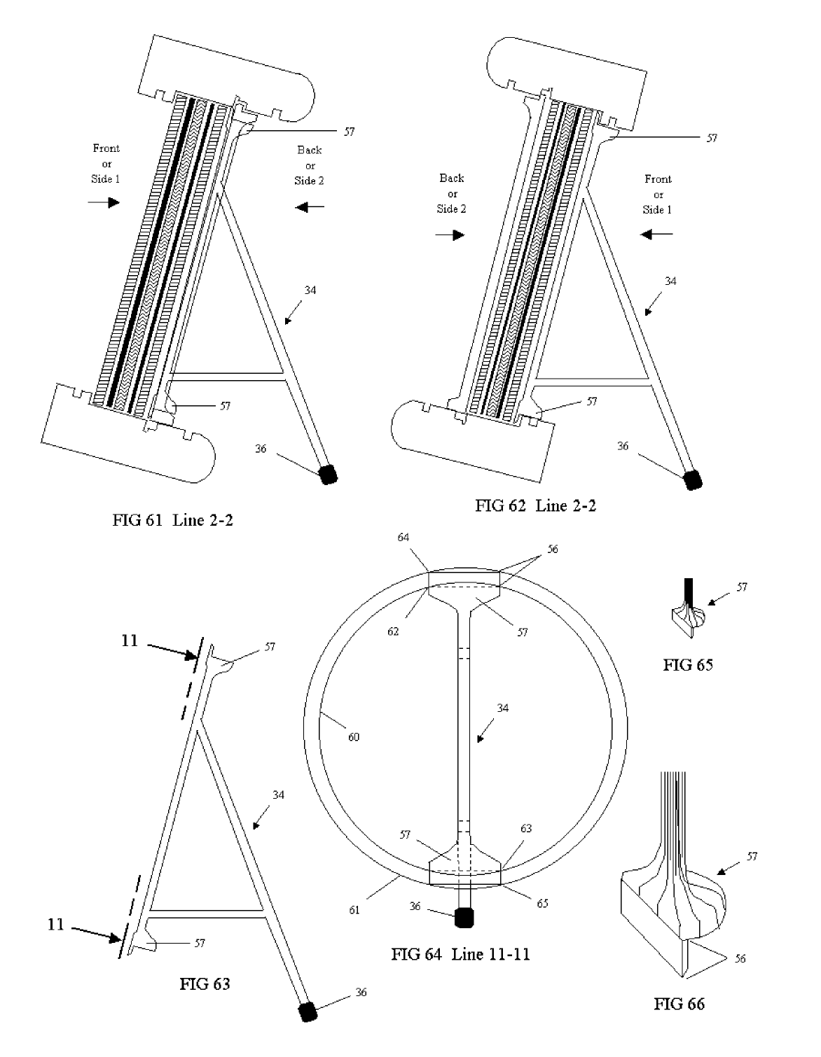

Drawings in FIGS. 55 thru 60 reveal an optional desktop frame support for wall mounted frames in FIGS. 1 and 8 of the present invention and comprises a nautilus frame wedge 51 with its built-in frame wedge foot 50 and two nautilus shell adornments. Nautilus frame wedge 51 shown in FIG. 57 is made of metal, wood, plastic, cast or materials known to the art and can be cast, cut, formed, poured, fabricated and the like with techniques used in the art. This support should usually have a black, brass, chrome or white looking finish to add a fashionable touch and compliment any frame finish.

To install nautilus frame wedge 51, which fits snugly at the centerline between the frame and glass shown in FIGS. 2 and 55 or between the frame and plastic cover in FIGS. 10 and 13, hold nautilus frame wedge 51 vertically near the lower frame center. Gently press the lower edge of frame wedge foot 50 seen in FIG. 60 in between the frame and front or back glass 4 in FIG. 2 or plastic cover 41 or 45 in FIG. 10. Continue sliding wedge foot 50 into display chamber 13 in FIG. 2 or frame recess chamber 49 in FIG. 10 until a snug fit is achieved, as illustrated in FIGS. 55 and 56. This completes the installation.

The optional nautilus frame wedge 51 provides a desktop or flat surface viewing capability for small and medium wall mounted embodiments in accordance with the versatility intended for the present invention.

Drawings in FIGS. 61 thru 66 reveal an optional desktop frame support for wall mounted frames in FIGS. 1 and 8 of the present invention and comprises a large frame wedge 34 with its two frame wedge feet 57 and frame wedge boot 36. Large frame wedge 34 shown in FIG. 63 is made of metal, wood, plastic, cast or materials known to the art and can be cast, cut, formed, poured, fabricated and the like with techniques used in the art. This support should usually have a black, brass, chrome or white looking finish to add a fashionable touch and compliment any frame finish.

To install large frame wedge 34, which fits snugly at the vertical centerline between the frame and glass shown in FIGS. 2 and 62 or between the frame and plastic cover in FIG. 10, hold large frame wedge 34 near the frame center at the 10 AM position. Move large frame wedge 34 to the surface of the frame and gently press the lower and upper edges 56 of the two frame wedge feet 57 seen in FIGS. 63-66 in between the frame and front or back glass 4 in FIG. 2 or plastic cover 41 or 45 in FIG. 10. Continue to rotate clockwise carefully sliding the edges 56 of the two frame wedge feet 57 into top and bottom display chamber 13 in FIG. 2 or frame recess chamber 49 in FIG. 10 until a snug and vertical fit is achieved, as illustrated in FIGS. 61 and 62. This completes the installation.

Due to the positive attachment to large frame embodiments using large frame wedge 34, it is important to read the description of the drawing detail for FIG. 64 to insure accurate measurement calculations and a proper fit are achieved. The optional large frame wedge 34 provides a desktop or flat surface viewing capability for large wall mounted embodiments in accordance with the versatility intended for the present invention.

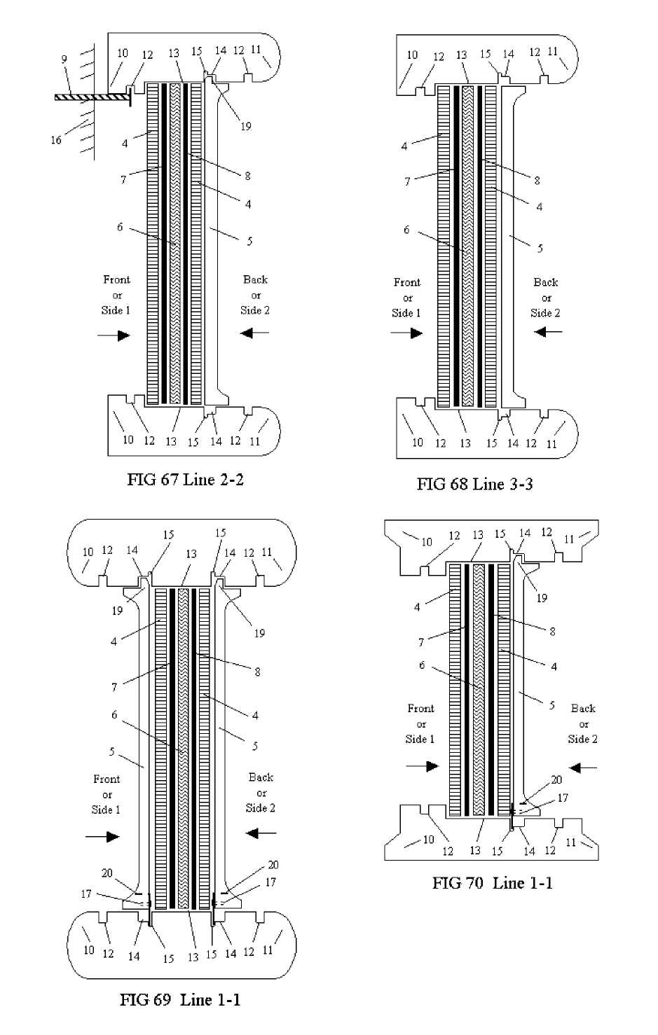

Drawings in FIGS. 67 thru 70 reveal more embodiments and features of the present invention, including frame shapes, configurations and feature variations that support the frame embodiment in FIGS. 1 thru 7 in accordance with the present invention.

While certain innovative features of this invention have been shown and described and are pointed out in the claims, it is not intended to be limited to the details above, since it will be understood that various omissions, modifications, substitutions and changes in the look and details of the preferred and exemplary embodiments of the present invention and in its construction materials can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of the present invention.

In order to optimize the following claims along with present invention embodiments and feature results, the exact materials and manufacturing techniques are best chosen by those skilled in the art. It is my intent that the present invention becomes a model to lead the prior art to a new age in picture frames. At a minimum it can easily compliment and spice up current picture frame collections.

1. I claim two-sided picture frame embodiments having opposite front and back sides, like or different finish, color, design, texture and look, made of available art materials that when assembled, molded, formed or the like, comprises: a front frame with a viewable picture area; a front hanging channel; a front side glass, plexiglass, acrylic or the like; one or more front pictures; a backing member; one or more back pictures; a back side glass, plexiglass, acrylic or the like; a locking member with attached locking units; a back hanging channel and a back frame with a viewable picture area. The hanging channel on the front and the back sides are utilized to hang picture frame embodiments and the like on walls or other surfaces, horizontally or vertically, on either the front or the back side of said two-sided picture frame embodiments as further described in claim 4 and claim 5.

2. Two-sided picture frame embodiments having opposite front and back sides, like or different finish, color, design, texture and look, made of available art materials that when assembled, molded, formed or the like, comprises: a front frame with viewable picture area; a front hanging channel; a flexible front side clear plastic, mylar or similar cover material that is attached at the top inside the front frame to open, close and extend inside and beyond the viewable picture area within the frame recess chamber, thus securing the front picture in the front frame; one or more front pictures under said clear front cover; a rigid support member; one or more back pictures under said clear back cover; a flexible back side clear plastic, mylar or similar cover material attached inside the top back frame to open, close and extend inside and beyond the viewable picture area within the frame recess chamber, thus securing the back picture in the back frame; a back hanging channel and a back frame with viewable picture area. The hanging channel on the front and the back sides are utilized to hang picture frame embodiments and the like on walls or other surfaces, horizontally or vertically, on either the front or the back side of said two-sided picture frame embodiments as further described in claim 5 and claim 9.

3. Two-sided picture frame embodiments having opposite front and back sides, each side having like or different colors, objects and features, made of flexible plastic, leather, fabric, or available materials, but may also be made of rigid materials that when assembled comprises: the shape of the object it depicts such as but not limited to a basketball, baseball, soccer ball, birthday cake, heart, cruise ship, hot air balloon, a rose, pumpkin or other objects; a front frame with picture viewing area containing a flexible clear plastic, mylar or similar cover material attached to the inside of the front frame; one or more front pictures; a center member; one or more back pictures and a back frame with picture viewing area containing a flexible clear plastic, mylar or similar cover material attached to the inside of the back frame. For this embodiment a visible hole is located at the balance point near the top of the frame to hang embodiments on a wall or other surface. For round like embodiments said hole can be hidden by locating the hole in a small tab slightly above the edge of the frame and hanging it with said tab folded behind the frame to hide the hole and nail therein. The front picture, center member and back picture slide simultaneously downward into the center pouch opening that is accessed along the top of the frame between the front and back frame layers.

4. A combination of materials, methods and procedures, cuts, channels, grooves, notches or the like are made to allow two-sided picture frame embodiments to hang, open, close and function, so that when frame moldings, molds, and the like are produced, assembled, cast, formed, or otherwise made, two-sided picture frame embodiments are created as described in claim 1 and comprise the following frame cross-section, going from the front side to the back side of the picture frame: Between the front side outer frame edge and the picture display chamber a front hanging channel is made; a deeper picture display chamber is made to contain the front glass, one or more front pictures, a backing member, one or more back pictures and the back glass contents; a still deeper and narrow locking channel is made into which locking units on the locking member rotate downward to secure the bottom of the locking member to the frame; a locking lip channel is made less deep than the narrow locking channel but deeper than the picture display chamber to secure the locking lip on the top of the locking member into the locking lip channel; a locking member channel area is made at the same depth as the picture display chamber to allow the bottom of the locking member to rotate to open the frame with the attached locking units in the upward or open position, a back hanging channel is made between the locking member channel area and the back side edge of the frame.

5. A way, idea and means to hang picture frames horizontally or vertically on walls and other surfaces comprising and utilizing intended hanging channels, notches, slots, grooves, pits, nooks, edges, or any hole-like, lip-like, depression or ridge-like areas positioned and endowed to allow picture frames to rest, balance or otherwise hang from a fixed object. Said way, idea and means may be built into, inherent, constructed, affixed to, or otherwise made part of the picture frame in a continuous or non-continuous fashion or combinations therein, and is so endowed to allow said frames to be hung on nails, screws, pins or other fixed objects for viewing, displaying and the like, in a vertical or horizontal fashion to view the front side of one sided picture frame embodiments and the front side or the back side of two-sided picture frame embodiments. Some frame designs should use non-continuous or mini hanging channels, notches, grooves, pits, colors and the like, to minimize, disguise, blend and further endow the present invention so as to complement the intended subject and picture frame features.

6. Two-sided picture frame embodiments described in claim 1 without glass or protective clear cover in the front or back sides of the frame for oil paintings, raised or textured art, miscellaneous objects, memorabilia and the like where glass is not used, and, or for contents made on thicker materials. Some frame designs should use non-continuous or mini hanging channels, notches and creative methods to minimize, disguise, blend and endow the present invention so as to complement the intended subject and picture frame features.

7. Two-sided picture frame embodiments described in claim 1 and claim 2 that have flat frame edge surfaces that allow them to free stand on desktops, shelves, tables, furniture and other horizontal surfaces so both sides may be enjoyed more readily. Said frames may also be rested and leaned on commercially available picture frame holders or on wedge accessories identified in claim 8 to enhance presentation and personal preference.

8. Wedge accessories for resting, leaning or otherwise supporting picture frames in claim 1, in claim 2 and beyond, so named wedge because it comprises: a thin and flat edge on a generally triangular shaped unit that is slowly and gently wedged between the inside edge of a picture frame and it's glass or contents, at the base of the frame near it's center, to support the frame at an angle suitable for desktop or flat surface viewing; two covers made of plastic, rubber or suitable materials protect the remaining two pencil shaped edges of the triangle, which contact the center of the resting and leaning frame and the desktop or flat surface respectively giving stability and support when displaying said picture frames. These wedges can be made, formed or otherwise manufactured in various sizes and variations for small to medium picture frames of plastic, metal, wood or other available materials using methods and techniques known to the art to construct, finish, add colors, designs and the like.
A second and much larger wedge version supports large picture frames and comprises: a much larger version of the present invention described in the paragraph above only having two thin and flat edges on a generally triangular shaped unit instead of one, which slowly and gently wedges between the top and bottom inside edges of a resting and leaning picture frame to provide additional strength and rigidity, and uses a rotating technique towards a vertical position to insert the large wedge. The large wedge must be specifically made to match the inside dimensions and features of the frame it is intended for in order to function properly.
A third version for small to medium picture frames, named the nautilus frame wedge, is more ornate, and comprises: a thin and flat edge on one end of a rather S shaped unit that has been rotated 90 degrees clockwise, which is slowly and gently wedged between the inside edge of a picture frame and it's glass or contents at the base of the frame near it's center to support the resting and leaning picture frame at an angle suitable for desktop or flat surface viewing; from the inserted flat wedge end of the unit it curves upward to contact and give resting and leaning support to the lower center area of the picture frame. It also branches outward from the picture frame briefly where it creates a nautilus shell shaped spiral within itself for decoration. Then reverse curves downward to contact and get support from said desktop surface, and finally reverse curves upward where it creates a second nautilus shell shaped spiral within itself for decoration. Nautilus frame wedge can be made, formed or otherwise manufactured in various sizes and variations for small to medium picture frames of plastic, metal, wood or other available materials using methods and techniques known to the art to construct, finish, add colors, designs and the like.

9. A combination of materials, methods and procedures, cuts, channels, grooves, notches or the like are made to allow two-sided picture frame embodiments to hang, open, close and function, so that when frame moldings, molds, and the like are produced, assembled, cast, formed, or otherwise made, two-sided picture frame embodiments are created as described in claim 2 and comprise the following picture frame cross-section: Between the front side outer frame edge and the front frame recess chamber a front hanging channel is made; a narrow and deeper front frame recess chamber is made to contain the front clear plastic mylar access cover and one or more front pictures; a rigid support member completely divides the front and the back sides of the picture frame embodiment; between the back side outer frame edge and the back frame recess chamber a back hanging channel is made; a narrow and deeper back frame recess chamber is made to contain the back clear plastic mylar access cover and one or more back pictures.

10. A combination of materials, methods and procedures, cuts, holes or the like are made to allow two-sided picture frame embodiments to hang, open, close and function, so that when frame moldings, molds, and the like are produced, assembled, cast, formed, or otherwise made, two-sided picture frame embodiments are created as described in claim 3 and comprise the following picture frame cross-section: A front side frame cover with a front side picture viewing area therein; a front side clear plastic, mylar or similar cover pocket; one or more front pictures; a center member; one or more back side pictures; a back side frame cover with a back side picture viewing area therein; a back side clear plastic, mylar or similar cover pocket; a hole through the front and back frame cover, located at the balance point near the top, is used to hang the embodiment on a wall or other surface.
